(19) United States
(12) Patent Application Publication
(10) Pub. No.: US 2025/0189220 A1
(43) Pub. Date: Jun. 12, 2025

(54) SYSTEM AND METHOD FOR SEPARATING METHANE FROM LIVESTOCK GASES

(71) Applicant: Ben J. Geboe, Norwalk, CT (US)

(72) Inventor: Ben J. Geboe, Norwalk, CT (US)

(21) Appl. No.: 18/968,295

(22) Filed: Dec. 4, 2024

Related U.S. Application Data
(60) Provisional application No. 63/606,870, filed on Dec. 6, 2023.

(51) Int. Cl. F25J 3/06; B01D 53/00

(52) U.S. Cl. CPC F25J 3/0695; B01D 53/002; F25J 3/0605; F25J 3/0635; B01D 2257/7025; B01D 2258/0266

(57) ABSTRACT

A system for capturing livestock-generated methane includes a collector configured to collect gases emitted from a livestock facility. The system further includes a freezer configured to receive the collective gases from the collector and freeze the collective gases. Furthermore, the system includes a separator valve configured to receive frozen collective gases from the freezer and segregate frozen methane from the frozen collective gases. The system additionally includes a methane gas collector configured to receive the frozen methane from the separator valve.

### CROSS REFERENCE TO RELATED APPLICATION

This application claims the benefit of priority of U.S. provisional application No. 63/606,870, filed on 6 Dec. 2023, the contents of which are herein incorporated by reference.

### BACKGROUND OF THE SUBJECT DISCLOSURE

The present subject disclosure relates generally to systems and methods for separating gases, and more particularly to a system and method for separating methane from other livestock gases produced through freezing the collective livestock gases and segregating the frozen methane from the other frozen collective livestock gases, thereby collecting ambient methane from livestock facilities.

Demand for dairy products and beef has increased considerably over the past few decades. Consequently, many cow farms are being established to meet the increased demand. Enteric fermentation is a digestive process in ruminant animals that produces methane as a byproduct. For example, it is estimated that a cow emits approximately 250-500 liters of methane every day. Farm operators typically try to capture emitted methane for its commercial value. Methane is also captured to reduce greenhouse gas emissions from cow production.

Conventional approaches to capturing methane include the use of membranes to separate methane from other gases found in air. However, methane membranes are still experimental and not in use in commercial farming production because of known drawbacks. Another conventional approach includes the use of food additives such as red algae supplements to prevent digestive methane from developing. However, such food additives are also in the developmental phase and not in commercial use, as the long-term impact on the health of the animal and thus the meat consumed by end users is not fully understood.

As can be seen, there is a need for a system that effectively captures methane produced by livestock at a commercial scale. The present subject disclosure solves these issues by providing a system and method for separating methane from other gases produced by livestock particularly by freezing the gases.

### SUMMARY OF THE SUBJECT DISCLOSURE

In accordance with embodiments of the subject disclosure, there is provided a system to capture methane. The system includes a collector configured to collect gases emitted from a livestock facility. The system further includes a freezer configured to receive the gases from the collector and freeze the gases. Furthermore, the system includes a separator valve configured to receive frozen gases from the freezer and segregate frozen methane from the collective frozen gases. The system additionally includes a methane gas collector configured to receive the frozen methane from the separator valve.

The system, as described herein the present disclosure, relies on the physical property of methane that is heavier than other gases when frozen. This assists in making an efficient and commercially scalable system for methane capture from livestock facilities, including but not limited to cow barns. The system may also be used to capture automobile emissions, thereby reducing emission of greenhouse gases into the atmosphere, and controlling global warming.

In one aspect of the present subject disclosure, a system for capturing and separating livestock-generated methane from other livestock generated gases includes a collector configured to collect gases emitted from a livestock facility; a freezer configured to receive the collective gases from the collector and hyper-cool the collective gases; and a separator valve configured to receive the collective gases from the freezer and segregate a methane portion from the collective gases, wherein the collector may be a tent enclosing the livestock facility.

In another aspect of the present subject disclosure, the system for capturing and separating livestock-generated methane from other live-stock-generated methane further includes wherein the separator valve provides a separator plate that physically separates a methane outlet and a remainder outlet of the separator valve, whereby the methane portion, being the heaviest of the collective gases, is the substantially the only gas of the collective gases to flow through the methane outlet, wherein the methane outlet is disposed vertically downward of the remainder outlet during use, wherein the separator valve and the separator plate have a shared longitudinal length that ranges between two to six inches; and further providing a methane gas collector configured to receive the hyper-cooled methane portion from the separator valve.

These and other features, aspects and advantages of the present subject disclosure will become better understood with reference to the following drawings, description and claims.

### BRIEF DESCRIPTION OF THE DRAWINGS

FIG. 1 depicts a schematic diagram of an example methane separation system in accordance with embodiments of the subject disclosure.

FIG. 2 depicts a horizontal cross-sectional view of a separating valve of the system of FIG. 1 in accordance with embodiments of the subject disclosure.

FIG. 3 depicts a vertical cross-sectional view of the separating valve of the system of FIG. 1 in accordance with embodiments of the subject disclosure.

### DETAILED DESCRIPTION OF THE SUBJECT DISCLOSURE

The following detailed description is of the best currently contemplated modes of carrying out exemplary embodiments of the subject disclosure. The description is not to be taken in a limiting sense but is made merely for the purpose of illustrating the general principles of the subject disclosure, since the scope of the subject disclosure is best defined by the appended claims.

Broadly, an embodiment of the present subject disclosure provides a system and method for separating methane from other gases produced in livestock facilities by freezing the gases, wherein the gases may include but are not limited to CH4, CO2, NH3, N2, O2, H2S, and N2O.

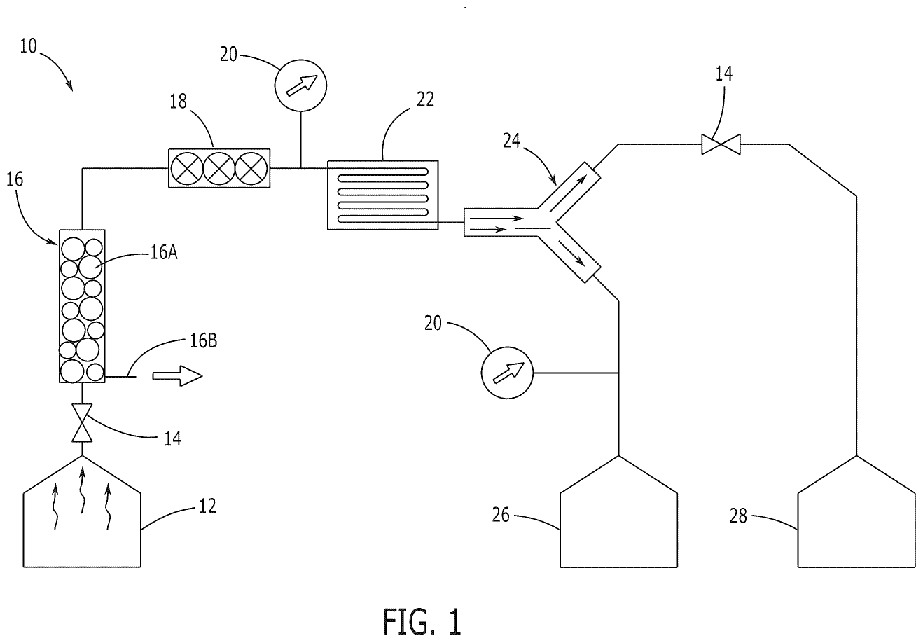

FIG. 1 depicts a schematic diagram of an example methane separation system 10 (or system 10) in accordance with embodiments of the subject disclosure. System 10 includes one or more components including, but not limited to, a tent collector 12, a vacuum suction 14, a moisture trap 16, a step-down cooling chamber 18, a gas level sensor 20, a cryo-freezer 22, a separating valve 24, a methane collector tank 26 and a CO2 and other gas collector tank 28.

In some embodiments, the tent collector 12 is installed over a livestock facility where ruminant animals are kept. The tent collector 12 is configured to capture the gases emitted by the ruminant animals. In an exemplary embodiment, the tent collector 12 is installed 10 feet above the livestock facility to effectively capture the emitted gases. The tent collector 12 may be made using lightweight cloth, plastic sheets or any other material sufficiently impermeable to gases typically emitted from livestock facilities, such as but not limited to cow barns, so such gases are sufficiently ‘trapped’, preventing passage to the external environment beyond the tent collector 12. In some embodiments, the tent collector 12 could be within the space defined by the livestock facility (e.g., below the roofline and walls).

The vacuum suction 14 is configured to capture or draw the trapped gas mixture/gases by the tent collector 12. The vacuum suction 14 may be made of conventional vacuum suction components.

Responsive to capturing the gases, vacuum suction 14 urges the gases to the moisture trap 16 which may be connected to the vacuum suction 14 through conduits, including but not limited to copper/PVC pipes. The moisture trap 16 may contain silica gel balls or other moisture-capturing elements 16A configured to which trap moisture present in the collective gases. When the gases pass through the moisture trap 16, the moisture-capturing elements 16A trap the moisture. The moisture trapped by the moisture-capturing elements 16A is released by a moisture outlet 16B that is present in the moisture trap 16.

When the moisture is removed from the gases by moisture trap 16, the gases pass through the step-down cooling chamber 18. The step-down cooling chamber 18 is configured to cool the gases. In certain embodiments, the step-down cooling chamber 18 is connected to the gas level sensor 20 that senses or detects the amount of gases/methane in the collective gas mixture input into and output by the step-down cooling chamber 18.

The “cooled” gases output by the step-down cooling chamber 18 is received by the cryo-freezer 22. The cryo-freezer 22 is configured to freeze or hyper-cool the gases. In some embodiments, cryo-freezer 22 includes a copper coil wire that freezes the gases.

The gases output by the cryo-freezer 22 may be received by the separating valve 24 in gaseous form (though in some embodiments one or more of the gases of the collective gases may or may not be in a liquid state or a solid state). The inventor has determined that operation with frozen gases/methane requires less safety precautions than the liquid CH4, which also may fall under regulatory requirements for storage or use. Note for frozen gasses the air is only frozen as it is passed through the freezing coils and separator, and then reverts to ambient temperature as fast as it exits the separation valve into a CH4 tube or the exhaust tube for other gasses.

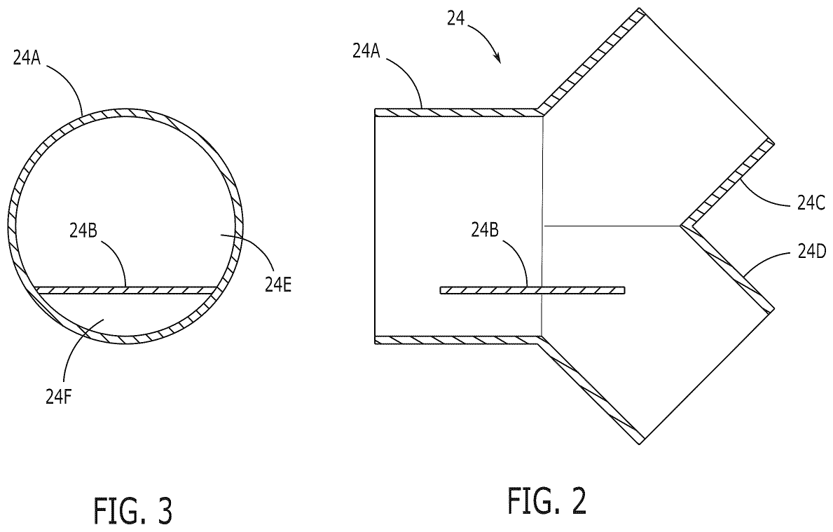

In certain embodiments the temperature induced by the cryo-freezer 22 is just below the condensation and deposition temperature, a hyper-cooled temperature, of at least methane if not all other relevant gases of the collected livestock gases. In certain embodiments, the separating valve 24 has a dividing wall or separator plate (shown as separator plate 24B in FIGS. 2 and 3) that separates the bottom 10% of gases that have a heavy concentration of methane because it is heavier than other gases when frozen.

In some embodiments, the length of the separator valve 24 may be, for example, four inches and the diameter of the separator valve 24 may be, for example, in a range of one to twelve inches. The separator valve 24 may be made up of materials such as copper or PVC. The separator valve 24 may be used to separate methane from other gases. Specifically, the separator valve 24 may separate hyper-cooled (or “frozen”) methane from other hyper-cooled collective gases so that the frozen methane passes to the methane collector tank 26 (for use as fuel or for other applications), and other gases may be passed to the CO2 and other gas collector tank 28 (via the vacuum suction 14).

FIGS. 2 and 3 depict cross-sectional views of the separator valve 24. The separator valve 24 includes an in-feed pipe 24A that receives the gases output from the cryo-freezer 22. The separator valve 24 further includes the separator plate 24B that separates heavier (relative to the remaining gases of the hyper-cooled collective gases) hyper-cooled methane as it sinks to the bottom of the separator valve 24. The separator plate 24B may separate the in-feed pipe 24A into two parts, 24E and 24F. The part 24F may pass the methane gas to the methane collector tank 26, and the part 24E may pass CO2 and other gases to the CO2 and other gas collector tank 28. The part 24E may cover 90% of the area of the separator valve 24 (i.e., gas passage area), and the part 24F may cover 10% of the area of the separator valve 24. In certain embodiments, the position of the separator plate 24B inside the separator valve 24 may be automatically adjusted according to the amount of methane present in the gases, which may be detected by the gas level sensor 20.

In certain embodiments, the separator plate 24B is soldered, welded, glued or cast in the in-feed pipe 24A. The separator plate 24B may be located approximately two inches inside the separator valve 24. Further, the separator plate 24B may be made of copper or PVC.

In some embodiments, the length of the separator valve 24 (specifically, the length of the in-feed pipe 24A) is in a range of two to six inches, e.g., approximately four inches. The length of the separator plate 24B may also be equivalent to the length of the separator valve 24. Further, the diameter of the separator valve 24 (specifically, the diameter of the in-feed pipe 24A) may be in a range of one to twelve inches.

When the frozen gases pass through the separator valve 24, methane, being heavier than other gases when frozen, is separated by the separator plate 24B and may pass through a methane out-funnel 24D and get collected in the methane collector tank 26. The methane out-funnel 24D may be disposed or arranged at the bottom part of the separator valve 24. The methane collected in the methane collector tank 26 may be used as an energy source for generating electricity, or for other applications.

The other gases may be pulled, “sucked” or urged through the vacuum suction 14, via the upper gases-out funnel 24C, and may be collected in the CO2 and other gas collector tank 28 which may be connected to the top outlet of the separator valve 24. The other gases-out funnel 24C may be disposed at the upper part of the separator valve 24.

A person ordinarily skilled in the art may appreciate that the present disclosure relies on exploiting the naturally present properties of methane which is heavier when frozen. System 10 is used in live animal cow farming and provides farmers with a way to separate methane for other uses or storage, which prevents release of methane in the atmosphere as a pollutant Green House Gas. The separator valve 24 is an effective way to separate frozen methane because it separates heavier methane from other gases, allowing it to be diverted for storage or other uses. Also, the subject disclosure contemplates use of the collected methane in a methane electric generator.

In further embodiments, the separator valve 24 may be used to separate other gases which may be, but are not limited to, carbon, ammonia, oxygen, etc., based on different freezing/boiling points of the gases. System 10 may also be used to reduce industrialized processing systems that create pollution such as coal burning energy plants whose emissions can be reduced by using a similar process as described above.

In additional embodiments, the separator valve 24 may be calibrated to capture gases emitted from automobiles, waste dumps/plants, and sewage plants.

As used in this application, the term “about” or “approximately” refers to a range of values within plus or minus 10% of the specified number. And the term “substantially” refers to up to 80% or more of an entirety. Recitation of ranges of values herein are not intended to be limiting, referring instead individually to any and all values falling within the range, unless otherwise indicated, and each separate value within such a range is incorporated into the specification as if it were individually recited herein.

For purposes of this disclosure, the term “aligned” means parallel, substantially parallel, or forming an angle of less than 35.0 degrees. For purposes of this disclosure, the term “transverse” means perpendicular, substantially perpendicular, or forming an angle between 55.0 and 125.0 degrees. Also, for purposes of this disclosure, the term “length” means the longest dimension of an object. Also, for purposes of this disclosure, the term “width” means the dimension of an object from side to side. For the purposes of this disclosure, the term “above” generally means superjacent, substantially superjacent, or higher than another object although not directly overlying the object. Further, for purposes of this disclosure, the term “mechanical communication” generally refers to components being in direct physical contact with each other or being in indirect physical contact with each other where movement of one component affect the position of the other.

The use of any and all examples, or exemplary language (“e.g.,” “such as,” or the like) provided herein, is intended merely to better illuminate the embodiments and does not pose a limitation on the scope of the embodiments or the claims. No language in the specification should be construed as indicating any unclaimed element as essential to the practice of the disclosed embodiments.

In the following description, it is understood that terms such as “first,” “second,” “top,” “bottom,” “up,” “down,” and the like, are words of convenience and are not to be construed as limiting terms unless specifically stated to the contrary.

It should be understood, of course, that the foregoing relates to exemplary embodiments of the subject disclosure and that modifications may be made without departing from the spirit and scope of the subject disclosure as set forth in the following claims.

What is claimed is:

1. A system for capturing and separating livestock-generated methane from other livestock-generated gases, the system comprising:
a collector configured to collect gases emitted from a livestock facility;
a freezer configured to receive the collective gases from the collector and hyper-cool the collective gases; and
a separator valve configured to receive the collective gases from the freezer and segregate a methane portion from the collective gases.

2. The system of claim 1, wherein the separator valve provides a separator plate that physically separates a methane outlet and a remainder outlet of the separator valve, whereby the methane portion, being the heaviest of the collective gases, is the substantially the only gas of the collective gases to flow through the methane outlet.

3. The system of claim 2, wherein the methane outlet is disposed vertically downward of the remainder outlet during use.

4. The system of claim 3, wherein the separator valve and the separator plate have a shared longitudinal length that ranges between two to six inches.

5. The system of claim 1, further comprises a methane gas collector configured to receive the hyper-cooled methane portion from the separator valve.

6. The system of claim 1, wherein the collector is a tent enclosing the livestock facility.
